(19) United States
(12) Patent Application Publication
(10) Pub. No.: US 2014/0152569 A1
(43) Pub. Date: Jun. 5, 2014

(54) INPUT DEVICE AND ELECTRONIC DEVICE

(71) Applicant: QUANTA COMPUTER INC., Kuei Shan Hsiang (TW)

(72) Inventors: Yun-Cheng Liu, Kuei Shan Hsiang (TW); Chien-Hung Lin, Kuei Shan Hsiang (TW)

(73) Assignee: Quanta Computer Inc., Kuei Shan Hsiang (TW)

(21) Appl. No.: 13/804,003

(22) Filed: Mar. 14, 2013

(30) Foreign Application Priority Data
Dec. 3, 2012 (TW) 101145228

(51) Int. Cl. G06F 3/02

(52) U.S. Cl. CPC G06F 3/021
USPC 345/168

(57) ABSTRACT

An input device applied on an electronic device including a keyboard, an image-detection module, and a processing device. There is a selection-operating area, a gesture-operating area, and a key-in area above the keyboard. The image-detection module is embedded in the keyboard for detecting the location of the user's hand. The processing device informs the electronic device to operate in either the selection-operating mode, the gesture-operating mode, or the key-in mode, according to the location of the hand as detected by the image detector.

### CROSS REFERENCE TO RELATED APPLICATIONS

This application claims priority of Taiwan Patent Application No. 101145228, filed on Dec. 3, 2012, the entirety of which is incorporated by reference herein.

### BACKGROUND OF THE INVENTION

1. Field of the Invention

The disclosure relates generally to electrical input devices and methods, and more particularly to gesture and touch input methods and devices.

2. Description of the Related Art

With the rapid progress of science and technology, the input methods of electronic devices are becoming increasingly diverse. From the beginning of the keyboard input to the emergence of touch technology, input methods for the electronic devices are becoming more intuitive.

With the increasing diversity of user experience, users have found that keyboard input and touch input each has its own advantages and disadvantages. Clicking a user interface by touch input is more intuitive, while typing text by keyboard input is quicker and has the convenience of already being in widespread use. Therefore, effective integration of keyboard input and touch input technology is required to meet users' needs when operating the different functions of electronic devices.

### BRIEF SUMMARY OF THE INVENTION

In view of this, an input device for an electronic device is provided, which includes a keyboard, wherein there is a selection operation region, a gesture operation region, and a keyboard input region on top of the keyboard; an image-detection module embedded in the keyboard used to detect the position of the hand; and a processing device notifying the electronic device to operate in either the selection operation mode, the gesture operation mode, or the keyboard input mode, according to the position of the hand as detected by the image-detection module.

An embodiment of the invention also provides an electronic device which includes a display; a keyboard, wherein there is a selection operation region, a gesture operation region, and a keyboard input region between the top of the keyboard and the display; an image-detection module embedded in the keyboard between the keyboard and the display used to detect the position of the hand; and a processing device operating in either the selection operation mode, the gesture operation mode, or the keyboard input mode, according to the position of the hand as detected by the image-detection module.

An embodiment of the invention provides an input method adopting to an electronic device, which includes detecting the position of the hand and notifying the electronic device to operate in either the selection operation mode, the gesture operation mode, or the keyboard input mode, according to the position of the hand. There is a selection operation region, a gesture operation region, and a keyboard input region on top of the electronic device, wherein the electronic device operates in the selection operation mode when the position of the hand is in the selection operation region, the electronic device operates in the gesture operation mode when the position of the hand in the gesture operation region, and the electronic device operates in the keyboard input mode when the position of the hand in the keyboard input region. The electronic device has an operation surface and a virtual plane which is above as well as on the leading edge of the electronic device and is substantially vertical to the operation surface, wherein the gesture operation region and the keyboard input region are sequentially located between the virtual surface and the operation surface, and the virtual plane is at the junction of the selection operation region and the gesture operation region.

### BRIEF DESCRIPTION OF DRAWINGS

The invention can be more fully understood by reading the subsequent detailed description and examples with references made to the accompanying drawings, wherein:

FIG. 1 is a block diagram of the input device 100 according to an embodiment of the invention;

FIG. 2 is a side view of the input device 200 according to an embodiment of the invention;

FIG. 3 is a top view of the input device 300 according to an embodiment of the invention;

FIG. 4 is a block diagram of the electronic device 400 according to an embodiment of the invention;

FIG. 5 is a side view of the electronic device 500 according to an embodiment of the invention;

FIG. 6 is a top view of the input device 600 according to another embodiment of the invention;

FIG. 7 is a top view of the input device 700 according to an embodiment of the invention;

FIG. 8 shows the image of the electronic device 800 detected by the left image detection unit 602;

FIG. 9 shows the image of the electronic device 900 with the hand waving left as detected by left image detection unit 602;

FIG. 10 is a schematic diagram of the hand moving into the selection operation region as detected by the left image detection unit 602;

FIGS. 11A-B are schematic diagrams of a method to calibrate the determination of a selected position in selection operation mode according to an embodiment of the invention;

FIG. 12 is a schematic diagram of the position of the hand located by the image-detection module according to an embodiment of the invention; and

FIG. 13 is a flow chart of the operation of the electronic device according to an embodiment of the invention.

### DETAILED DESCRIPTION OF THE INVENTION

To clearly explain the purpose, the characteristics, and the advantages of the invention, preferred embodiments are illustrated hereinafter with the accompanying drawings as follows:

The following description is of the best-contemplated mode of carrying out the invention. This description is made for the purpose of illustrating the general principles of the invention and should not be taken in a limiting sense. The scope of the invention is best determined by reference to the appended claims.

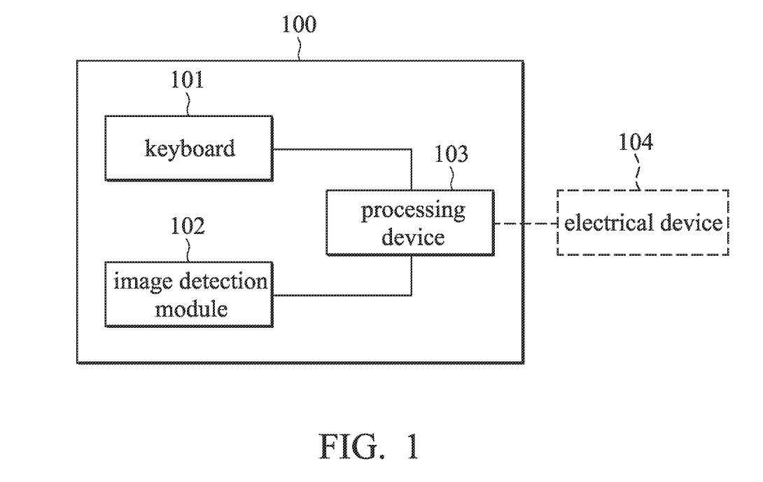

FIG. 1 is a block diagram of the input device 100 according to an embodiment of the invention. An embodiment of the input device 100 can be implemented in the electronic device 104, such as personal or laptop computer.

The input device 100 includes the keyboard 101, the image-detection module 102, and the processing device 103, where the input device 100 is coupled to the electronic device 104. In some embodiments, the electronic device 104 includes a display and a system host, and input data from the input device 100 is displayed on a display of the electronic device 104 by way of the system host of the electronic device 104.

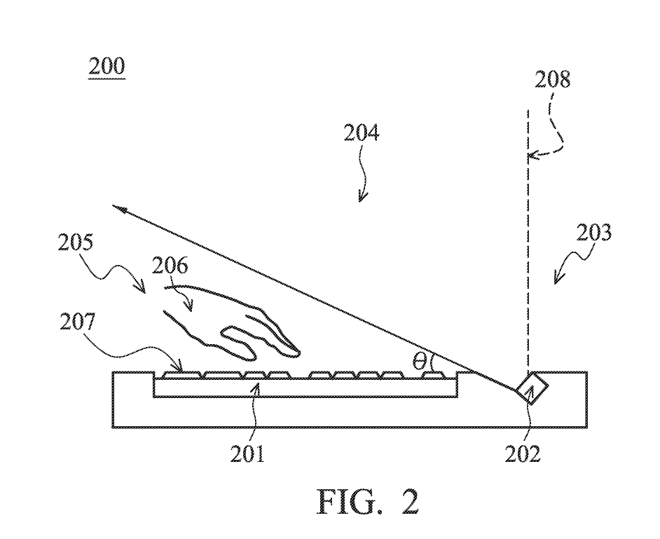

FIG. 2 is a side view of the input device 200 according to an embodiment of the invention. An embodiment of the input device 200 includes the keyboard 201, the image-detection module 202, and a processing device (not shown in FIG. 2). There are the selection operation region 203, the gesture operation region 204, and the keyboard input region 205 on top of the keyboard 201. The image-detection module 202, embedded in the operation surface of the keyboard 201, detects the position of the hand 206. The processing device (not shown in FIG. 2) operates in either the selection operation mode, the gesture operation mode, or the keyboard input mode, according to the position of the hand as detected by the image-detection module 202.

The keyboard 201 comprises the operation surface 207, and there is a virtual surface 208 vertical to the operation surface 207 at the leading edge of the operation surface 207, wherein the gesture operation region 204 and keyboard input region 206 are located between the virtual plane 208 and the operation surface 207, and the virtual plane 208 is at the junction of the selection operation region 203 and the gesture operation region 204.

According to an embodiment of the invention, the image-detection module 202 is embedded in the keyboard 201 and tilted at an angle. When a hand is placed on the operation surface 207, the position of the hand can't be detected by the image-detection module 202, and the input device 200 is notified to operate in keyboard input mode. According to another embodiment of the invention, the image-detection module 202 is not tilted at an angle but notifies the input device 200 to operate in the keyboard input mode when the position of the hand is in some parts of the viewing angle detected by the image-detection module 202. For example, when the viewing angle of the image-detection module 202 is large enough to cover the keyboard input region 205, the processing device (not shown in FIG. 2) defines a specified area near the keyboard (such as the angle relative to the image-detection module 202 and the operation surface 207 less the specified angle θ) as the keyboard input region 205 and the processing device notifies the input device 200 to operate in the keyboard input mode when the hand 206 is detected in this region.

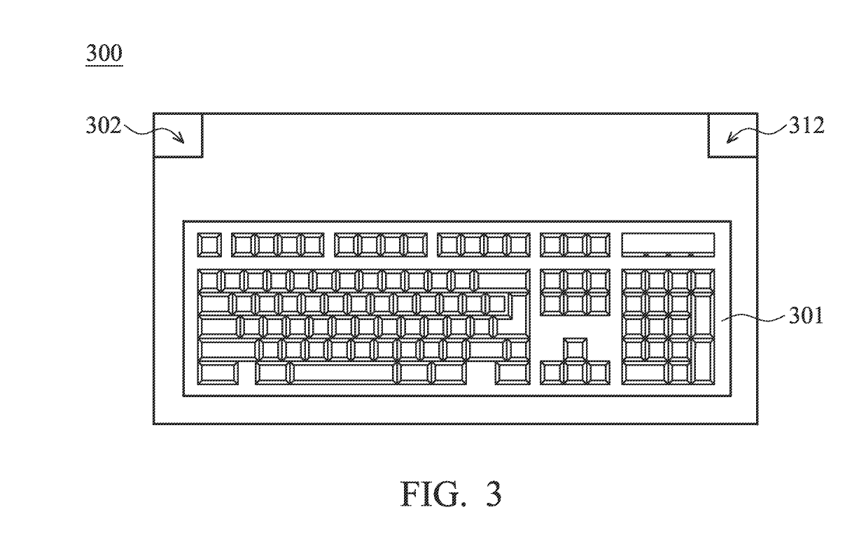

FIG. 3 is a top view of the input device 300 according to an embodiment of the invention. According to an embodiment of the invention, the image-detection module 102 comprises the left image detection unit 302 and the right image detection unit 312, embedded on each side of the keyboard 301 away from the user.

According to an embodiment of the invention, the left image detection unit 302 and right image detection unit 312 may include an image sensor and an active light source. The active light source emits a light beam, which can be visible light or light outside the visible spectrum. According to a preferred embodiment of the invention, the active light source is an infrared light source which emits an infrared light beam reflected by the hand and then received by the image sensor so that the position of the hand can be determined. According to another embodiment of the invention, the active light source is not necessary and can be replaced with ambient light. According to some embodiments of the invention, the image sensor may comprise a CMOS sensor or CCD.

It should be noted that the above is just an embodiment used for reference, and is not intended to be limiting. One with skill in this art, without departing from the spirit and scope of the invention, may do some modifications and variations so that the embodiments mentioned above are not used to limit the scope of the invention.

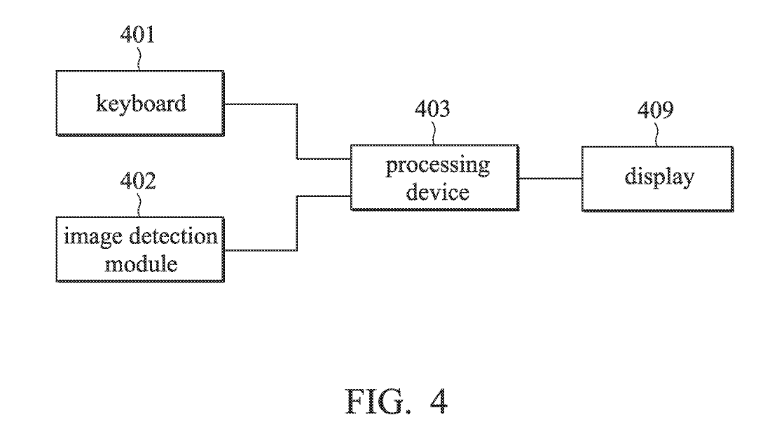

FIG. 4 is a block diagram of the electronic device 400 according to an embodiment of the invention. The electronic device 400 includes the keyboard 401, the image-detection module 402, the processing device 403, and the display 409. In some embodiments, the processing device 403 shows the information on the display 409 according to the position of the hand as detected by the image-detection module 402 and the input information entered by the keyboard 401 or the gesture detected by the image-detection module 402.

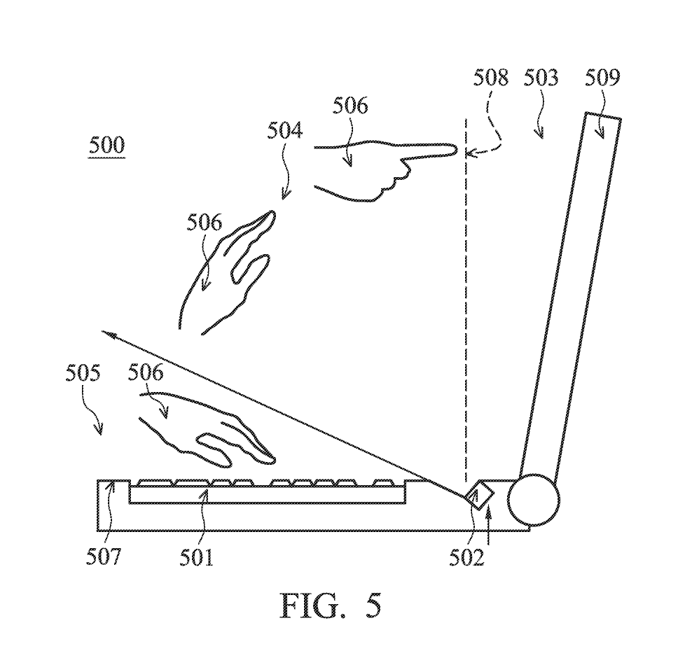

FIG. 5 is a side view of the electronic device 500 according to an embodiment of the invention. The electronic device 500, according to an embodiment of the invention, includes the keyboard 501, the image-detection module 502, the processing device (not shown in FIG. 5), and the display 509, where the leading edge of the keyboard 501 is connected with the display 509. The selection operation region 503, the gesture operation region 504, and the keyboard input region 505 are located sequentially from the display 509 to the top of the keyboard 501, and the junction of the selection operation region 503 and the gesture operation region 504 is the virtual plane 508. The image detection module 502 embedded on the leading edge of the keyboard 501 and between the keyboard 501 and the display 509 is used to detect the position of the hand 506. The processing device (not shown in FIG. 5) operates in either the selection operation mode, the gesture operation mode, or the keyboard input mode, according to the position of the hand 506 as detected by the image-detection module 502.

The keyboard 501 comprises an operation surface 507 and the area between the operation surface 507 and the display 509 is divided into three regions which are in the order of the selection operation region 503, the gesture operation region 504, and the keyboard input region 505. The junction between the selection operation region 503 and the gesture operation region 504 is the virtual plane 508.

According to an embodiment of the invention, the image-detection module 502 is embedded in the keyboard 501 and tilted at an angle so that the position of the hand 506 is not detected by the image-detection module 502 and the input device 200 is not notified to operate in keyboard input mode when the hand 506 is placed on the operation surface 507. When the hand 506 is placed on the operation surface 507 of the keyboard 501, the hand 506 can be detected by the image-detection module 502 as long as the hand 506 is vertically raised and the processing device (not shown in FIG. 5) operates in the gesture operation mode immediately. According to another embodiment of the invention, the image-detection module 502 need not tilt at an angle. As long as the hand is detected in some parts of the viewing angle, the input device 200 is notified to operate in keyboard input mode. It should be noted that the above is not limited by the embodiment of FIG. 5 but also is adopted in the embodiment of FIG. 2.

According to the embodiment of FIG. 5, when the hand 506 is placed in the gesture operation region 504 and is detected by the image-detection module 502, the processing device (not shown in FIG. 5) operates in the gesture operation mode and controls the screen shown on the display 509 according to the gesture of the hand 506. When the hand 506 is placed in the selection operation region 503, the processing device (not shown in FIG. 5) operates in the selection operation mode and clicks the icon shown on the display 509 or moves the cursor shown on the display 509 corresponding to the position of the hand 506 as detected by the image-detection module 502. When the hand 506 is placed in the keyboard input region 505, the hand 506 is not detected by the image-detection module 502 so that the processing device (not shown in FIG. 5) operates in the keyboard input mode and the input information of the keyboard 501 is shown on the display 509.

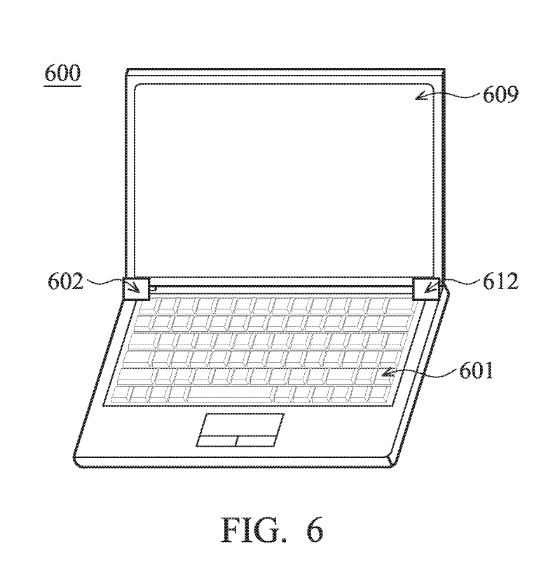

FIG. 6 is a top view of the input device 600 according to another embodiment of the invention. The image-detection module 502 has the left image detection unit 602 and the right image detection unit 612 which are respectively located on the keyboard 601 and near the junction between the keyboard 601 and the display 609, where the field of view of the left image detection unit 602 overlaps with that of the right image detection unit 612 in complementarity.

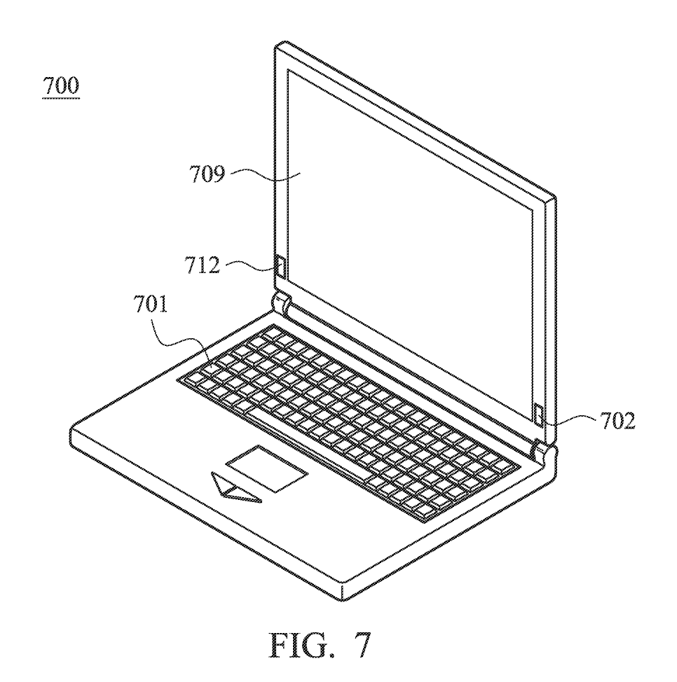

FIG. 7 is a top view of the input device 700 according to an embodiment of the invention. The image-detection module 502 comprises the left image detection unit 702 and the right image detection unit 712, which are respectively located on the display 709 and near the junction of the keyboard 701 and the display 709, and spin with the rotation of the display 709. According to another embodiment of the invention, the left image detection unit 702 and the right image detection unit 712 of the electronic device 700 are located on the rotating shaft between the keyboard 701 and the display 709 and spin with the rotation of the display 709. In addition, the field of view of the left image detection unit 702 is overlapping with that of the right image detection unit 712 in complementarity.

The gesture operation region, the selection operation region, and the keyboard input region are characterized as per the following, according to the embodiments of FIG. 5 and FIG. 6, but they are not limited thereto. The embodiment of FIG. 2 is adopted as well.

The Gesture Operation Region

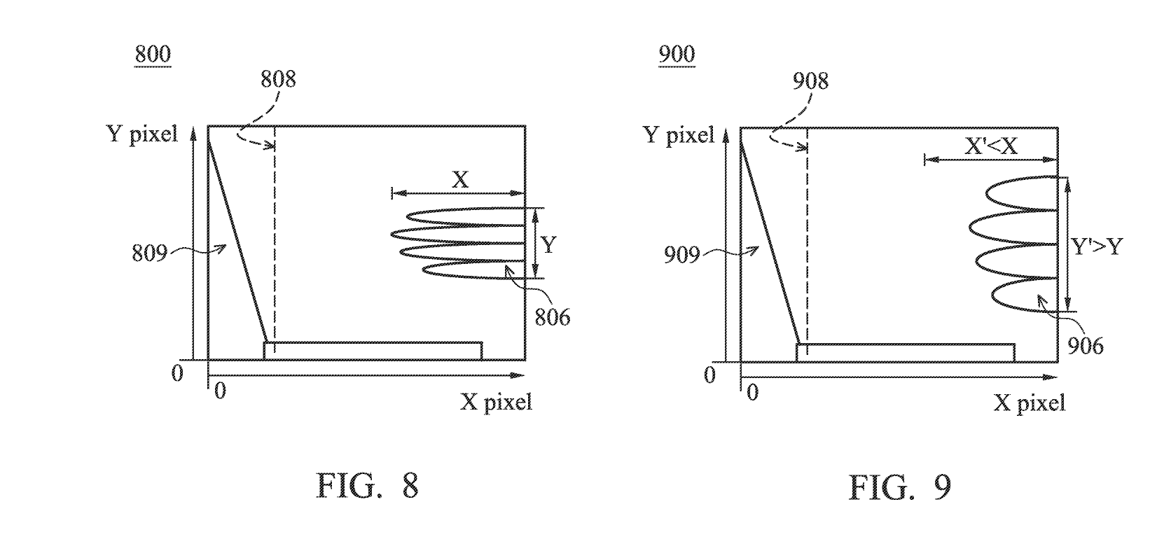

FIG. 8 shows the image of the electronic device 800 detected by the left image detection unit 602. When the hand 806 is detected by the image detection unit 602 but not across the virtual plane 808, the hand 806 is in a specified gesture, such as four fingers pointing on the display 809 (only it is illustrated herein, but this is not limiting to the scope of the invention), to initialize the gesture operation mode, and the system state of the electronic device 800 is initialized and the screen of the display 809 is controlled by the movement of the hand 806 to scroll page down or to browse.

FIG. 9 shows the image of the electronic device 900 with the hand waving left, as detected by left image detection unit 602. For example, when the hand 906 is waving left, the finger length becomes shorter and the finger width becomes wider, according to the left image detection unit 602. Referring to FIG. 8 and FIG. 9, as long as the shortened length of the X axis and the lengthened length of the Y axis of the hand 906 are detected by the left image detection unit 602, the electronic device 900 executes the left paging or the left browsing. Likewise, as long as the right waving of the hand 906 is detected by the left image detection unit 602, the length of the X axis of the hand 906 is shortened and that of the Y axis is shortened. In addition to the detection of the waving direction of the hand 906 by the left image detection unit 602, the detection result can be confirmed with the use of the right image detection unit 612. Moreover, the detection area is limited by the field of view of the detection unit with the use of a single image detection unit, while there is an advantage that there is a smaller dead zone with the use of two image detection units, and the selection of the field of view of the image detection unit is more flexible.

The Selection Operation Region

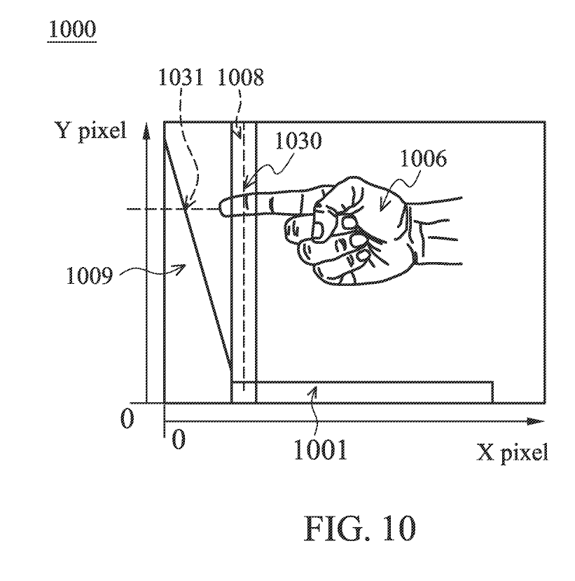

FIG. 10 is a schematic diagram of the hand moving into the selection operation region as detected by the left image detection unit 602. Illustrated with the image of the hand 1006 detected by the left image detection unit 602, when the hand 1006 is on top of the keyboard 1001 and across the virtual plane 1008 (that is, entering the selection operation region) as detected by the left image detection unit 602, the electronic device 1000 immediately operates in the selection operation region. At the same time, the finger position 1030 of the hand 1006 is located by the left image detection unit 602 and the right image detection unit 612 with a triangle calculation or slope calculation, that is, the clicking position on the screen of the pixel 1031 shown on the display 1009. As long as the clicking operation is accomplished and the hand 1006 is out of the virtual plane 1008, the electronic device 1000 immediately switches from the selection operation mode to the gesture operation mode. However, the virtual plane 1008 is not limited to a vertical plane but any predefined inclined surface. Each position is corresponding to that of each pixel in the image-detection module.

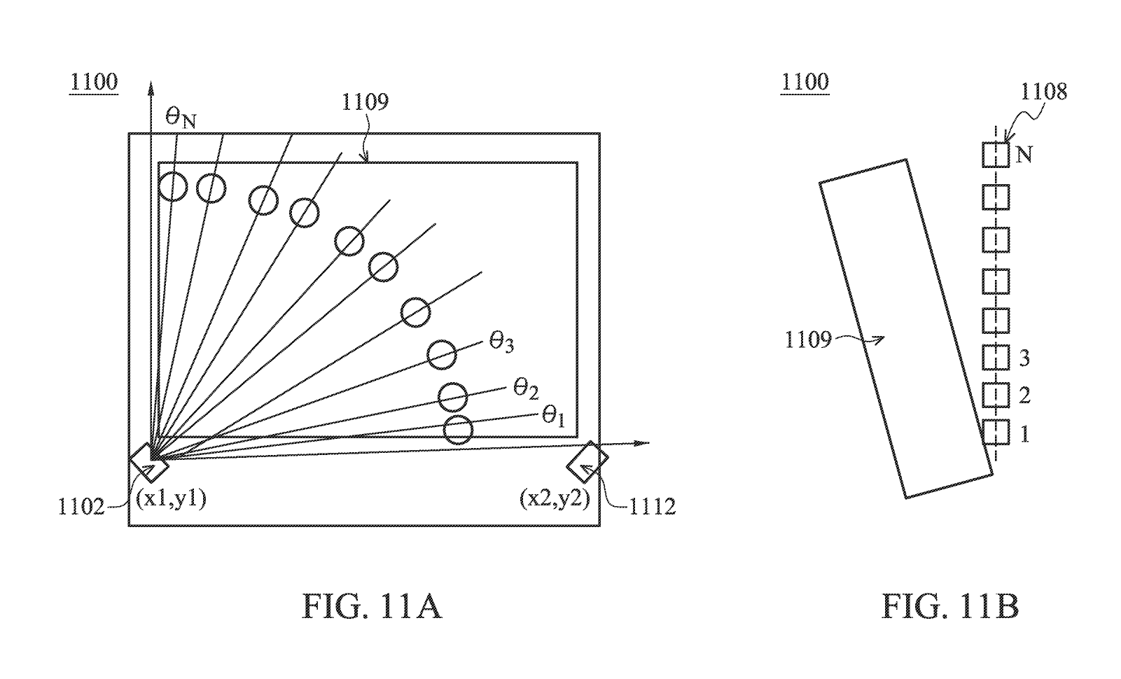

FIGS. 11A-B are schematic diagrams of how to calibrate the determination of a selected position in selection operation mode according to an embodiment of the invention. As shown in FIG. 11A, before the electronic device 1100 leaves the factory, there are many calibration points with known angles, which are located on the virtual plane 1108 (shown in the side view of FIG. 11B corresponding to the positions of the display 1109 shown in FIG. 11B), and which are recorded via the corresponding pixels in the left image detection unit 1102 and the right image detection unit 1112. Therefore, the database of the clicking positions of the virtual plane 1108 corresponding to the pixel of the display 1109 is accomplished.

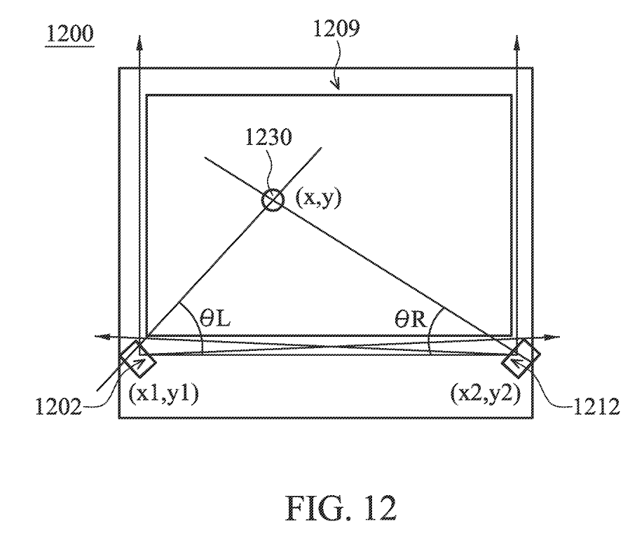

FIG. 12 is a schematic diagram of the position of the hand located by the image-detection module according to an embodiment of the invention. When the finger position 1230 is in the selection operation region, the left image detection unit 1202 and the right image detection unit 1212 determine the angle between the finger position 1230 and the left image detection unit 1202, and the angle between the finger position 1230 and the right image detection unit 1212, respectively, according to the calibrated database of the image detection pixels corresponding to the angles. According to the angle between the finger position 1230 and the left image detection unit 1202, the angle between the finger position 1230 and the right image detection unit 1212, and the distance between the left image detection unit 1202 and the right image detection unit 1212 (the distance between the left image detection unit 1202 and the right image detection unit 1212 is predetermined when the electronic device is shipped from the factory), the coordinates of the finger may be obtained by simple calculation (just for illustration but not limit thereto, by triangle calculation or slope calculation) and a clicking action or a cursor-moving action may be executed for the pixel of the display 1209.

According to another embodiment of the invention, in addition to a clicking action, a cursor-moving action may be executed as well in the selection operation mode. When executing a cursor-moving action, the finger position 1230 (shown in FIG. 12) persists in the selection operation region. According to the calibrated database of the image detection pixels corresponding to the angles, the left image detection unit 1202 and the right image detection unit 1212 sketch the locus of the moving finger position 1230 by immediately calculating the finger position 1230 with a simple math calculation, and the cursor of the electronic device 1200 moves along with the locus of the finger position 1230 on the display 1209.

The Keyboard Input Region

As shown in FIG. 5, because the image-detection module 502 is embedded in the leading edge of the operation surface 507 of the keyboard 501 and tilted at an angle as well, the position of the hand 506 is not in the field of view of the image-detection module 502 and the electronic device 500 operates in the keyboard input mode when the hand 506 is on the operation surface 507 of the keyboard 501. The screen is shown on the display 509 according to the input information from the keyboard 501, and the content on the display 509 may be controlled by the hand 506 with the use of the keyboard 501.

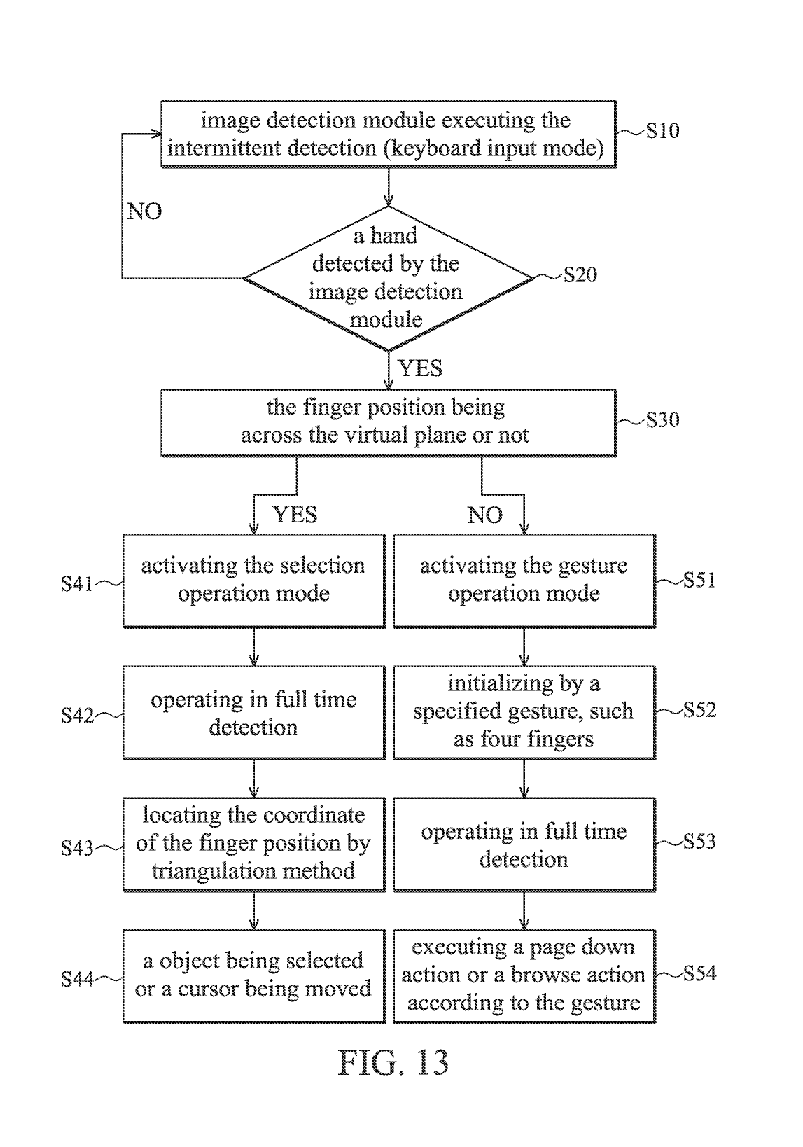

FIG. 13 is a flow chart of the operation of the electronic device according to an embodiment of the invention. When the electronic device is in standby, the image-detection module executes intermittent detection when the electronic device operates in the keyboard input mode (Step S10); if the hand is detected by the image-detection module (Step S20), it should be determined whether the finger position is across the virtual plane or not (Step 30).

If it is determined that the finger position is across the virtual plane, the selection operation mode is activated (Step S41); the image-detection module operates in full-time detection (Step S42); and then the left and right image detection units locate the coordinates of the finger position by a triangulation method (Step S43); an object is selected or a cursor is moved on the pixel corresponding to the finger position (Step S44). If it is determined that the finger position is not across the virtual plane, the gesture operation mode is activated (Step S51); the system state is initialized by a specified gesture, such as four fingers (Step S52); then, the image-detection module operates in full-time detection (Step S53); the electronic device executes a page down action or a browse action according to the gesture (Step S54).

While the invention has been described by way of example and in terms of preferred embodiments, it is to be understood that the invention is not limited thereto. Those who are skilled in this technology can still make various alterations and modifications without departing from the scope and spirit of the invention. Therefore, the scope of the present invention shall be defined and protected by the following claims and their equivalents.

What is claimed is:

1. An input device for an electronic device, comprising:
a keyboard, wherein there is a selection operation region, a gesture operation region, and a keyboard input region on top of the keyboard;
an image-detection module, embedded in the keyboard, detecting a position of a hand; and
a processing device notifying the electronic device to operate in either a selection operation mode, a gesture operation mode, or a keyboard input mode, according to the position of the hand as detected by the image-detection module.

2. The input device of claim 1, wherein:
the processing device notifies the electronic device to operate in the gesture operation region so that the electronic device operates according to a gesture of the hand when the hand is in the gesture operation region as detected by the image-detection module;
the processing device notifies the electronic device to operate in the selection operation region so that the electronic device operates according to the gesture when the hand is moved into the selection operation region from the gesture operation region as detected by the image-detection module; and
the processing device notifies the electronic device to operate in the keyboard input mode so that the electronic device operates according to a input information of the keyboard when the hand is not detected by the image-detection module.

3. The input device of claim 1, wherein the keyboard has an operation surface and there is a virtual plane which is above as well as on the leading edge of the electronic device, and which is substantially vertical to the operation surface, wherein the gesture operation region and the keyboard input region are sequentially located between the virtual surface and the operation surface, and the virtual plane is at a junction of the selection operation region and the gesture operation region.

4. The input device of claim 3, wherein the processing device notifies the electronic device to operate in the keyboard input mode when the hand is located in the keyboard input region.

5. The input device of claim 3, wherein the image-detection module is embedded in the leading edge of the operation surface of the keyboard and tilted at an angle so that the position of the hand may not be detected by the image-detection module when the hand is on the operation surface of the keyboard.

6. The input device of claim 1, wherein the image-detection module has two image detection units which are placed on both sides above the keyboard.

7. An electronic device, comprising:
a display;
a keyboard, wherein there is a selection operation region, a gesture operation region, and a keyboard input region between the top of the keyboard and the display;
an image-detection module, located between the keyboard and the display, used to detect a position of a hand; and
a processing device operating in either a selection operation mode, a gesture operation mode, or a keyboard input mode, according to the position of the hand as detected by the image-detection module.

8. The electronic device of claim 7, wherein:
when the hand is in the gesture operation region as detected by the image-detection module, the processing device operates in the gesture operation mode and controls a screen shown on the display according to a gesture of the hand;
when the hand is in the selection operation region as detected by the image-detection module, the processing device operates in the selection operation mode and selects an object on the screen corresponding to the position of the hand, or moves a cursor corresponding to the position of the hand as detected by the image-detection module; and
when the hand is not detected by the image-detection module, the processing device operates in the keyboard input mode and a input information of the keyboard is shown on the display.

9. The electronic device of claim 7, wherein the keyboard has an operation surface, and the area between the operation surface and the display is divided into three regions which are in the order of the selection operation region, the gesture operation region, and the keyboard input region, and a junction of the selection operation region and the gesture operation region is the virtual plane.

10. The electronic device of claim 7, wherein the processing device operates in the keyboard input mode when the hand is in the keyboard input region.

11. The electronic device of claim 7, wherein the image-detection module is embedded in a leading edge of an operation surface of the keyboard and tilted at an angle so that the position of the hand may not be detected by the image-detection module when the hand is on the operation surface of the keyboard.

12. The electronic device of claim 7, wherein the image-detection module has two image detection units which are placed on both sides above the keyboard.

13. The electronic device of claim 7, wherein the image-detection module is embedded in the keyboard and near a junction of the keyboard and the display.

14. The electronic device of claim 7, wherein the image-detection module is embedded in the display and near a junction of the keyboard and the display.
